(19) United States
(12) Patent Application Publication
(10) Pub. No.: US 2007/0177451 A1
(43) Pub. Date: Aug. 2, 2007

(54) Serrated kneading disk and kneading block

(76) Inventors: Craig A. Benjamin, Lebanon, OR (US); Matthew A. Warren, Salem, OR (US)

Correspondence Address: Robert E. Howard, P.O. Box 10345, Eugene, OR, 97440-2345, US

(21) Appl. No.: 11/346,693

(22) Filed: Feb. 2, 2006

(51) Int. Cl. B29B 7/58; A21C 1/00; B01F 7/00

(52) U.S. Cl. 366/82

(57) ABSTRACT

A serrated kneading disk including a body having a perimeter that is an ellipse having truncated ends, the curved elliptical portions forming flanks and the truncated ends forming crests. The crests are curved to form the arc of a circle having a radius substantially the same as the radius of the bore of the extruder barrel with which the disk is to be used. The disk body has a cylindrical passageway extending through the middle thereof, the passageway having a configuration adapted to allow the kneading disks to be lockingly engaged on the shaft of an extruder screw. A plurality of grooves are formed in the flanks and crests. A serrated kneading block can be formed from a plurality of the serrated kneading disks, or formed as a single body having a plurality of lobes, each lobe being substantially identical to the serrated kneading disk.

### BACKGROUND OF THE INVENTION

The present invention relates to serrated kneading disks, kneading blocks formed from a plurality of the serrated kneading disks, and single piece kneading blocks having serrated lobes.

Twin screw extruders are well known. Such extruders have two parallel, intersecting bores passing through an elongated extruder barrel. Each bore contains a rotatable screw element extending therethrough. The screw elements can be co-rotating, i.e., rotate in the same direction, or counter-rotating, i.e, rotate in opposite directions. However, the present invention is limited to co-rotating screw elements.

Each screw element is comprised of a shaft having compounding segments mounted along the shaft in a manner such that they intermesh with corresponding compounding segments mounted on the adjacent parallel screw element. The compounding segments typically include kneading elements, conveying elements, mixing elements, and other specialized elements.

The kneading elements are typically two or more kneading disks placed adjacent one another on an extruder screw shaft to form a kneading block. The kneading disks have truncated elliptical-shaped bodies having two crests spaced 180 degrees apart. An opening passes through the kneading disk body and has a configuration adapted to allow the kneading disks to be lockingly engaged on the shaft of a screw. The individual kneading disks in a kneading block have crests that are misaligned by pre-selected stagger angles.

The opposing kneading blocks in a typical twin screw extruder are fully intermeshing and self-wiping. They generate high and low shear regions, the high shear region being next to the crests, and the low shear region being in the screw channels.

While such prior art kneading disks and kneading blocks are satisfactory for processing polymeric materials, they are not as satisfactory for processing materials that require an extra degree of shearing and tearing such as, for example, high fiber materials such as wood and cereal grains or agglomerated materials.

### SUMMARY OF THE INVENTION

It is an object of the present invention to provide a kneading disk or kneading block that provides more satisfactory processing of fibrous materials in a co-rotating twin screw extruder.

The serrated kneading disk of the present invention includes a body having a perimeter that is an ellipse having truncated ends, the curved elliptical portions forming flanks and the truncated ends forming crests. The crests are curved to form the arc of a circle having a radius slightly less than the radius of the bore of the extruder barrel within which the disk is to be used. The disk body has a passageway extending through the middle thereof, the passageway having a configuration adapted to allow the kneading disks to be lockingly engaged on the shaft of an extruder screw.

A plurality of grooves are formed in the flanks and crests. The bottoms of the grooves are preferably sloped with at least one portion of the groove being deeper than another portion thereof However, the grooves can have a uniform depth.

A plurality of the serrated kneading disks can be placed adjacent one another on an extruder screw shaft to form a kneading block Alternatively, a kneading block can be formed as a single piece having lobes that are substantially identical to the individual serrated kneading disks.

### BRIEF DESCRIPTION OF THE DRAWINGS

FIG. 1 is an isometric view of the serrated kneading disk of the present invention;

FIG. 2 is a front elevational view of the serrated kneading disk;

FIG. 3A is a side elevational view of the serrated kneading disk;

FIG. 3B is a side elevational view of an alternative embodiment of the serrated kneading disk;

FIG. 4 is an enlarged elevational view of a portion of the flank of the serrated kneading disk;

FIG. 5A is a side elevational view taken along line 5-5 of FIG. 3A of a single groove of a first embodiment of the serrated kneading disk;

FIG. 5B is a side elevational view taken along line 5-5 of FIG. 3A of a single groove of a second embodiment of the serrated kneading disk;

FIG. 5C is a side elevational view taken along line 5-5 of FIG. 3A of a single groove of a third embodiment of the serrated kneading disk;

FIG. 5D is a side elevational view taken along line 5-5 of FIG. 3A of a single groove of a fourth embodiment of the serrated kneading disk;

FIG. 6A is a side elevational view of the serrated kneading disk showing a second embodiment of the groove pattern;

FIG. 6B is a side elevational view of the serrated kneading disk showing a third embodiment of the groove pattern;

FIG. 6C is a side elevational view of the serrated kneading disk showing a fourth embodiment of the groove pattern; and

FIG. 7 is an isometric view of a kneading block formed as a single element having a plurality of lobes identical to the serrated kneading disks of the present invention.

### DESCRIPTION OF PREFERRED EMBODIMENTS

The serrated kneading disk body 10 of the present invention has a perimeter that is an ellipse having truncated ends, the curved elliptical portions forming flanks 12, 12′ and the truncated ends forming crests 14, 14′. Crests 14, 14′ are the arc of a circle having a radius substantially corresponding to the radius of the bore of the twin screw extruder barrel within which it is to be used, with allowance for a small gap between the crests 14, 14′ and the wall of the bore. Serrated kneading disk has substantially flat faces 15, 15′ having major planes that are substantially parallel.

A cylindrical passageway 16 extends through the middle of kneading disk 10 between faces 15, 15′, the axis of cylindrical passageway 16 being located at the center of truncated ellipse perimeter of serrated kneading disk 10. A plurality of spline grooves 18 are formed in the face of cylindrical passageway 16, perpendicular to faces 15, 15′, and adapted to receive splines located on an extruder screw shaft. Alternatively, a plurality of splines (not shown) can be formed in the face of cylindrical passageway 16 adapted to be received in spline grooves formed in an extruder screw shaft.

Although the foregoing are the two preferred configurations for attaching kneading disk body 10 to a screw shaft, any configuration adapted to allow the kneading disk body 10 to be lockingly engaged on the shaft of an extruder screw can be used. For example, passageway 16 can have a hexagonal or a double hexagonal shape adapted to seat in a mating shape on the extruder screw shaft. Other alternative locking means includes any suitable arrangement of hubs and keyways, pins, etc.

A plurality of grooves 20 are formed (such as by machining) in that portion of the periphery of serrated disk 10 forming flanks 12, 12′, grooves 20 extending between faces 15, 15′. Similarly, a plurality of grooves 20 are formed in that portion of the periphery of serrated disk 10 forming crests 14, 14′, grooves 20 extending between faces 17, 17, which are slightly recessed from faces 15, 15′.

FIG. 4 provides an enlarged end view of adjacent grooves 20, which are shown as being semi-circular in cross-section. However, grooves 20 may have cross-sectional configurations other than a semi-circle, such as triangular.

Grooves 20 are preferably evenly spaced apart and preferably cover the entire surface of flanks 12, 12′ and crests 14, 14′. However, blank spaces 17, i.e., spaces having no grooves 20, may be left between adjacent sets of grooves 20 such as, for example, shown in FIG. 3B.

Grooves 20 may have a uniform depth between faces 15 and 15′ and between faces 17 and 17′, or may have a non-uniform (sloping) depth there between. Alternatively, some of grooves 20 may have a uniform depth between faces 15 and 15′ and between faces 17 and 17′, and other of grooves 20 may have a non-uniform (sloping) depth there between.

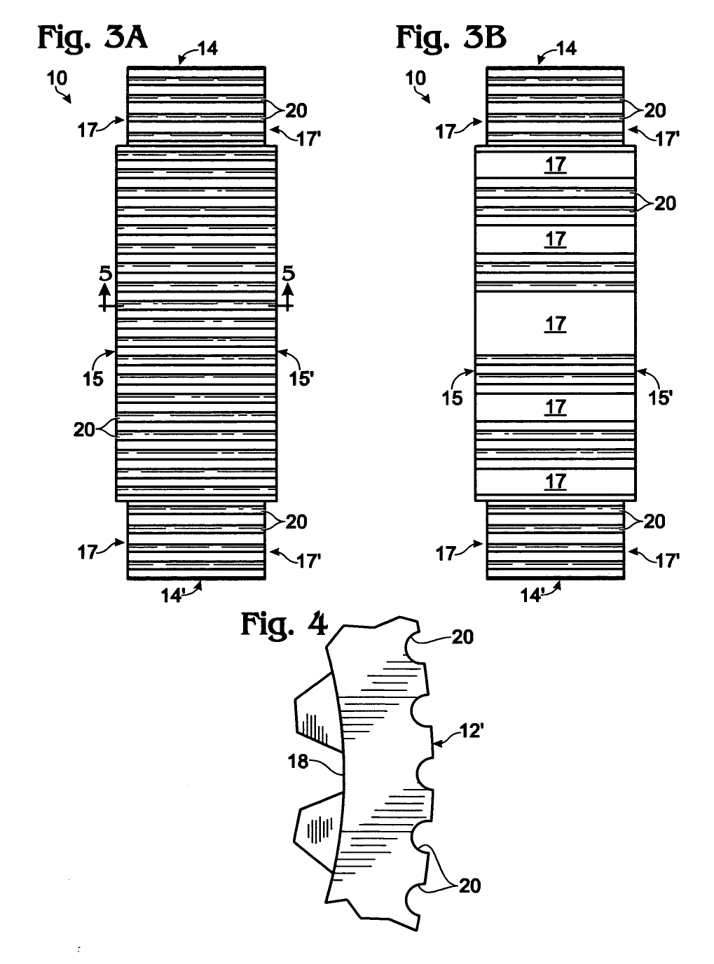

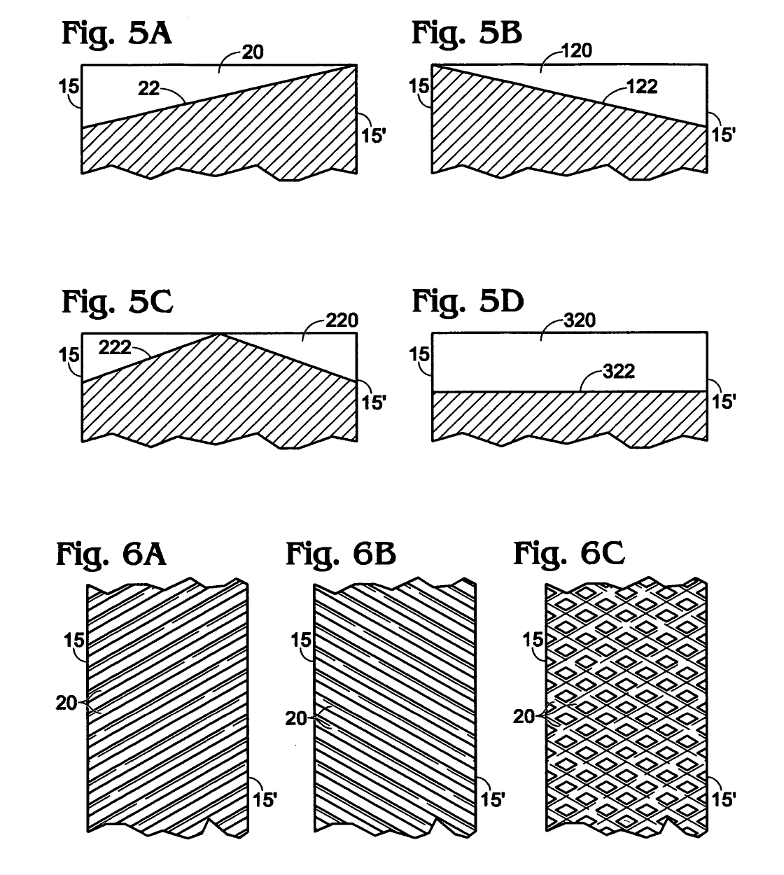

FIG. 5A shows a first embodiment of groove 20 taken along line 5-5 of FIG. 3. Groove 20 has a bottom 22 which slopes upwardly from face 15 to face 15′, going from a deep portion adjacent face 15 to a shallow portion adjacent face 15′.

FIG. 5B shows a second groove embodiment 120. Groove 120 has a bottom 122 which slopes downwardly from face 15 to face 15′, going from a shallow portion adjacent face 15 to a deep portion adjacent face 15′.

FIG. 5C shows a third groove embodiment 220. Groove 220 has a bottom 222 which slopes upwardly from face 15 to a mid-portion between face 15 and face 15′, and slopes downwardly from a mid-portion between face 15 and face 15′ to face 15′. Thus, groove 222 goes from a deep portion adjacent face 15 to a shallow portion adjacent the mid-portion between face 15 and face 15′, and goes from a shallow portion adjacent the mid-portion between face 15 and face 15′ to a deep portion adjacent face 15′.

FIG. 5D shows a fourth groove embodiment 320. Groove 320 has a bottom 322 having no slope, i.e., is uniform in depth between faces 15 and 15′.

It is to be understood that the second through fourth configurations of grooves 120-320 would appear on serrated kneading disk 10 in substitution of groove 20. It is to be further understood that identical groove configurations to those described as extending between faces 15 and 15′ would also extend between faces 17 and 17′.

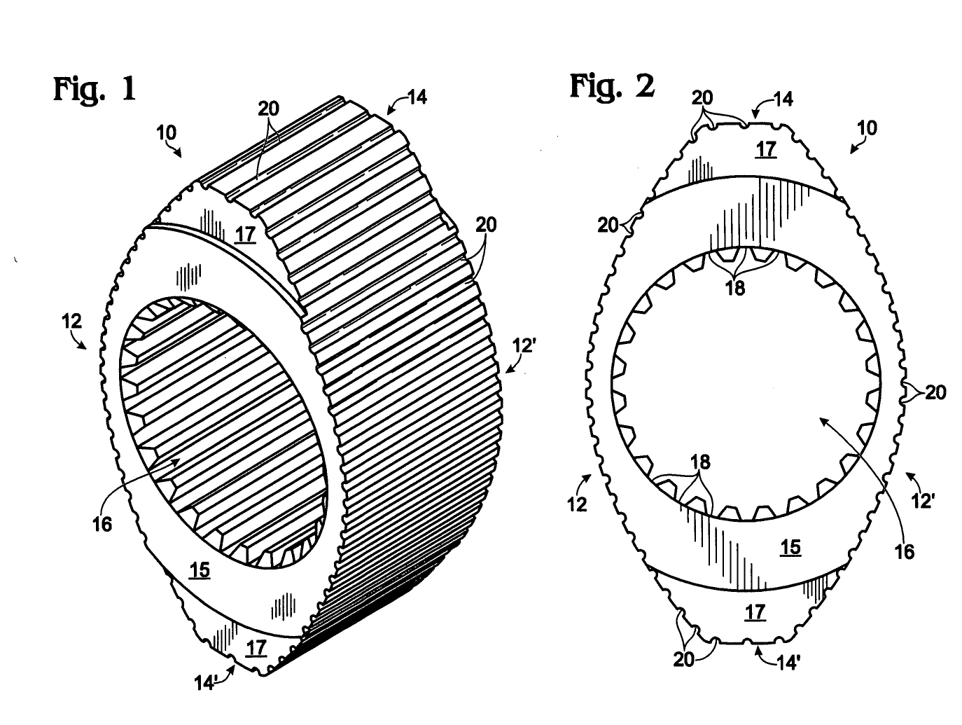

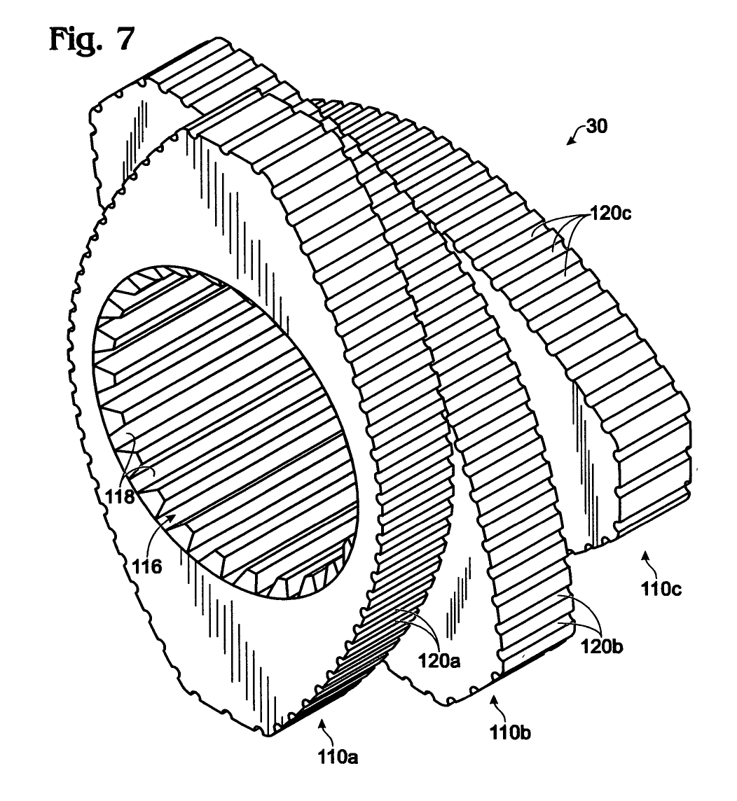

In the embodiment shown in FIGS. 1-5, grooves 20-320 are shown as being perpendicular to the major planes of faces 15, 15′. However, grooves 20 (and grooves 120-320) can be at an angle to the major planes of faces 15, 15′, as shown in FIGS. 6A and 6B. Also, angular grooves 20 shown in FIGS. 6A and 6B (and grooves 120-320) could be criss-crossed with a second set of angular grooves 20′, as shown in FIG. 6C. The same configurations would apply to grooves extending between faces 17 and 17′.

A plurality of serrated disks 10 can be assembled onto an extruder screw shaft in a manner well known in the art to form a kneading block. For example, three serrated kneading disks 10 could be inserted onto the splines of an extruder screw shaft in contact with one another, with their crests misaligned at desired stagger angles.

Alternatively, a kneading block can be formed as a single member instead of being formed from a plurality of serrated kneading disks 10. FIG. 7 shows such a kneading block body 30 having three identical lobes 110a, 110b, and 110c. Each lobe 110a, b, and c has a configuration identical to serrated kneading disk 10 described above. Thus, lobes 110a, b, and c each have a plurality of grooves 120a, 120b, and 120c, respectively, around the periphery thereof in the same manner as with grooves 20 of serrated kneading disk 10, and including all of the alternative groove embodiments shown in FIGS. 5 and 6 and described above relative to serrated kneading disk 10 .

A cylindrical passageway 116 extends through the middle of kneading block 110. A plurality of spline grooves 118 are formed in the face of cylindrical passageway 116, and are adapted to receive splines located on an extruder screw shaft. Alternatively, a plurality of splines (not shown) can be formed in the face of cylindrical passageway 116 adapted to be received in spline grooves formed in an extruder screw shaft.

Although the foregoing are the two preferred configurations for attaching kneading block 110 to a screw shaft, any configuration adapted to allow the kneading block 110 to be lockingly engaged on the shaft of an extruder screw can be used. For example, passageway 116 can have a hexagonal or a double hexagonal shape adapted to seat in a mating shape on the extruder screw shaft. Other alternative locking means includes any suitable arrangement of hubs and keyways, pins, etc.

It will be obvious to those having skill in the art that many changes may be made to the details of the above-described embodiments of this invention without departing from the underlying principles thereof. The scope of the present invention should, therefore, be determined only by the following claims.

The invention claimed is:

1. A serrated kneading disk comprising:
a body having a perimeter that is an ellipse having truncated ends, the curved elliptical portions forming flanks and the truncated ends forming crests, said crests being curved to form the arc of a circle, said body having first and second substantially flat faces having major planes that are substantially parallel to one another;
a cylindrical passageway extending through the middle of said body between said faces, said passageway having a configuration adapted to allow the kneading disks to be lockingly engaged on the shaft of an extruder screw; and
a plurality of grooves in said flanks and said crests, said grooves extending between said faces.

2. The serrated kneading disk of claim 1 wherein said grooves are spaced substantially uniformly apart, and extend between said faces around the entire perimeter of said body.

3. The serrated kneading disk of claim 1 wherein said grooves are arranged in groups with non-grooved portions in between.

4. The serrated kneading disk of claim 1 wherein said grooves are substantially perpendicular to the major planes of said faces.

5. The serrated kneading disk of claim 1 wherein said grooves are at an angle to the major planes of said faces.

6. The serrated kneading disk of claim 5 including a plurality of second grooves at an angle to said grooves to thereby form a criss-cross pattern.

7. The serrated kneading disk of claim 1 wherein said grooves have a semi-circular cross-section.

8. The serrated kneading disk of claim 1 wherein said grooves have a cross-section other than semi-circular.

9. The serrated kneading disk of claim 8 wherein said grooves have a triangular cross-section.

10. The serrated kneading disk of claim 1 wherein said grooves have a bottom that slopes from a deep end to a shallow end.

11. The serrated kneading disk of claim 10 wherein said grooves slope from a deep end adjacent one of said faces to a shallow end adjacent the other of said faces.

12. The serrated kneading disk of claim 10 wherein said grooves have a first slope from a deep end adjacent one of said faces to a shallow portion located between said faces, and a second slope from a shallow portion located between said faces to a deep end adjacent the other of said faces.

13. The serrated kneading disk of claim 1 wherein said grooves have a uniform depth between said faces.

14. The serrated kneading disk of claim 1 wherein some of said grooves have a uniform depth between said faces and other of said grooves have a non-uniform depth between said faces.

15. The serrated kneading disk of claim 1 wherein said cylindrical passageway has a plurality of spline grooves or splines formed in the face thereof substantially perpendicular to said faces and adapted to receive splines or spline grooves, respectively, located on an extruder screw shaft.

16. A serrated kneading block comprising:
a body having a plurality of lobes, each of said lobes having a perimeter that is an ellipse having truncated ends, the curved elliptical portions forming flanks and the truncated ends forming crests, said crests being curved to form the arc of a circle, said body having first and second substantially flat faces having major planes that are substantially parallel to one another;
a cylindrical passageway extending through the middle of said body between said faces, said passageway having a configuration adapted to allow the kneading disks to be lockingly engaged on the shaft of an extruder screw; and
a plurality of grooves in said flanks and said crests of each of said lobes, said grooves extending between said faces.

17. The serrated kneading block of claim 16 wherein said grooves are spaced substantially uniformly apart, and extend between said faces around the entire perimeter of each of said lobes.

18. The serrated kneading block of claim 16 wherein said grooves in each of said lobes are arranged in groups with non-grooved portions in between.

19. The serrated kneading block of claim 16 wherein said grooves in each of said lobes are substantially perpendicular to the major planes of said faces.

20. The serrated kneading block of claim 16 wherein said grooves in each of said lobes are at an angle to the major planes of said faces.

21. The serrated kneading block of claim 20 including a plurality of second grooves in each of said lobes that are at an angle to said grooves to thereby form a criss-cross pattern.

22. The serrated kneading block of claim 16 wherein said grooves in each of said lobes has a semi-circular cross-section.

23. The serrated kneading block of claim 16 wherein said grooves in each of said lobes have a cross-section other than semi-circular.

24. The serrated kneading block of claim 23 wherein said grooves in each of said lobes have a triangular cross-section.

25. The serrated kneading block of claim 16 wherein said grooves in each of said lobes have a bottom that slopes from a deep end to a shallow end.

26. The serrated kneading block of claim 25 wherein said grooves in each of said lobes slope from a deep end adjacent one of said faces to a shallow end adjacent the other of said faces.

27. The serrated kneading block of claim 25 wherein said grooves in each of said lobes have a first slope from a deep end adjacent one of said faces to a shallow portion located between said faces, and a second slope from a shallow portion located between said faces to a deep end adjacent the other of said faces.

28. The serrated kneading block of claim 16 wherein said grooves in each of said lobes have a uniform depth between said faces.

29. The serrated kneading block of claim 16 wherein some of said grooves in each of said lobes have a uniform depth between said faces and other of said grooves have a non-uniform depth between said faces.

30. The serrated kneading disk of claim 16 wherein said cylindrical passageway has a plurality of spline grooves or splines formed in the face thereof substantially perpendicular to said faces and adapted to receive splines or spline grooves, respectively, located on an extruder screw shaft.
